(19) United States
(12) Patent Application Publication
(10) Pub. No.: US 2015/0254357 A1
(43) Pub. Date: Sep. 10, 2015

(54) SOCIALLY RELEVANT AND ACTIVITY AWARE LOCAL SEARCH

(71) Applicants: Chandu THOTA, Saratoga, CA (US); Jennifer Dulski, Palo Alto, CA (US)

(72) Inventors: Chandu THOTA, Saratoga, CA (US); Jennifer Dulski, Palo Alto, CA (US)

(21) Appl. No.: 12/415,969

(22) Filed: Mar. 31, 2009

Related U.S. Application Data
(60) Provisional application No. 61/072,665, filed on Mar. 31, 2008.
(60) Provisional application No. 61/072,666, filed on Mar. 31, 2008.

(51) Int. Cl. G06F 17/30; G06F 15/16

(52) U.S. Cl. CPC G06F 17/30867; G06F 17/3053

(57) ABSTRACT

Techniques are provided for generating query results in response to a query that specifies a location, the query results comprising business entities located around the location that are spatially relevant and socially and/or activity relevant to the query. Web data is crawled and processed using natural language techniques to derive activity information for business entities. Query results are also generated in response to a query that specifies a location and an itinerary, the query results providing possible itineraries at or near the specified location.

This application claims priority and benefit under 35 U.S.C. §119(e) to U.S. Provisional Patent Application No. 61/072,665, entitled “Local Search”, filed on Mar. 31, 2008 and to U.S. Provisional Patent Application No. 61/072,666, entitled “Collaborative and Personalized Mapping”, filed on Mar. 31, 2008. The content of these applications are incorporated herein in their entirety by reference.

### FIELD OF THE INVENTION

The present invention is related to the filed of computer and network software, and more particularly to a method and apparatus for providing search results for location-based searches.

### BACKGROUND OF THE INVENTION

Users who wish to find business entities located around a particular location can use web-based search engines such as Yahoo! (http://www.yahoo.com and http://maps.yahoo.com) and Google (http://www.google.com and http://maps.google.com) by inputting a search query that includes information about the business entity and a location of interest, such as “daycare Saratoga, California”. Typically, after submitting such a search query, the user receives a list of search results that lists the business entities that correspond to the search term “daycare” in and around “Saratoga, California”, sorted in order of the distance between the physical location of a business entity and the location of interest.

After being provided a list of business entities that likely provide daycare in and around Saratoga, Calif., however, the user will typically have to conduct further research in determining which daycare provider best suits his or her needs. For example, the user may search for and read online reviews of the various daycare providers listed in the search results, investigate the daycare providers physically, and/or solicit comments, reviews, and recommendation from friends, co-workers, and neighbors about the various daycare providers. Such an investigation is time-consuming and entails conducting many more searches.

Review-sharing services such as Yelp (http://www.yelp.com) provide search results based on the relevance to search terms, but the search results include reviews retrieved from all the users. No mechanism is provided to filter the reviews in a manner that is socially relevant to the user who initiated the search.

Data on the web contains large amounts of information about business entities. Besides Yellow Page listings of the business entities, there are also reviews written by customers of the business entities on review sites, blog entries about the business entities, and forum posts about the business entities, among others. Currently, no mechanism is provided to crawl this data and to extract activity information from this data to assist in providing good search results when a user searches for specific types of activities.

In addition, to plan an itinerary that includes more than one single activity, users typically have to conduct multiple searches, where each activity in the itinerary is planned using at least one search. This is also time-consuming and involves many separate searches, where the user must manually coordinate information between the searches. In such cases, example queries are “romantic night out”, “kids day out”, “weekend trip”, etc.—which requires the compilation of lists comprising two or more places or business entities to satisfy the searches being performed.

Thus, there is a need for better techniques in providing socially relevant and activity aware location-based search results.

### SUMMARY OF THE INVENTION

The present invention is related a method and apparatus for providing socially relevant and activity aware location-based search results.

According to one aspect of the present invention, in response to receiving a query from a user, where the query specifies a location, a list of query results are generated. Each query result indicates a business entity located within a vicinity of the specified location. Furthermore, the query results are ranked within the list of query results based on both spatial relevance and social relevance. The spatial relevance of a query result indicates how far the business entity indicated by the query result is away from the specified location. The social relevance of a query result indicates how users who are socially connected to the user have rated the business entity. The spatial relevance and the social relevance of a query result may be combined in a weighted manner to generate a composite score and this composite score may be used to rank the query results in order to provide a ranked list of socially relevant and location-based query results for the user's review.

According to one aspect of the present invention, in response to receiving a query from a user, where the query specifies a location, a list of query results are generated. Each query result indicates a business entity located within a vicinity of the specified location. Furthermore, the query results are ranked within the list of query results based on both spatial relevance and activity relevance. The spatial relevance of a query result indicates how far the business entity indicated by the query result is away from the specified location. The activity relevance of a query result's business entity indicates how relevant the business entity is to an activity indicated in the query. The spatial relevance and activity relevance of the business entities may be combined in a weighted manner to generate a composite score for each query result and the composite score may be used to rank the query results to provide a ranked list of activity aware and location-based query results to the user for review.

In furtherance of these and other aspects, web data associated with a business entity is processed using natural language techniques to derive activity information for the business entity. The derive activity information may be stored in a computer-readable storage medium that is then accessed when assessing how relevant the business entity is to a particular activity.

According to one aspect of the present invention, in response to receiving a query from a user, where the query specifies a location and an itinerary, a plurality of sub-queries is generated for the query. Each generated sub-query indicates a particular activity. Then, for each sub-query, a list of query results is generated where each query result in the list of query results indicates a business entity located in the vicinity of the specified location that is relevant to the particular activity. The list of sub-query results for each sub-query may be ranked based on both the spatial proximity/relevance and the activity relevance of the sub-query results. Then, all the lists of sub-query results may be combined and provided to the user as query results for the specified itinerary (lists of places matching the activity criteria) at the specified location.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates an exemplary social network for a user who has submitted a query.

FIG. 2 illustrates different dimensions of relevance, including spatial relevance and social relevance.

FIG. 3 illustrates a system that may be used to implement aspects of the present invention.

FIG. 4 illustrates three lists of activity aware query results.

FIG. 5 illustrates an example sentence that may be parsed and processed according to natural language processing techniques to derive features-based activity information.

FIG. 6 illustrates a system that may be used to implement aspects of the present invention.

FIG. 7 illustrates different dimensions of relevance, including spatial relevance, social relevance, and activity relevance.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to one aspect of the present invention, in response to receiving a query from a user, where the query specifies a location, a list of query results are generated. Each query result indicates a business entity located within a vicinity of the specified location. Furthermore, the query results are ranked within the list of query results based on both spatial relevance and social relevance. The spatial relevance of a query result indicates how far the business entity indicated by the query result is away from the specified location. The social relevance of a query result indicates how users who are socially connected to the user have rated the business entity. The spatial relevance and the social relevance of a query result may be combined in a weighted manner to generate a composite score and this composite score may be used to rank the query results in order to provide a ranked list of socially relevant and location-based query results for the user's review.

In an illustrative example, a user who wishes to find daycare providers in and around Saratoga, Calif., submits a query for “daycare” in “Saratoga, California”. Upon receiving this query, a list of query results is generated where each query result in the list indicates a business entity that provides daycare in the vicinity of Saratoga, Calif. For example, two query results may indicate “ABC Daycare” and “XYZ Daycare”, respectively, as daycare providers in Saratoga, Calif. A query result may additionally indicate Yellow Page information about the business entity, such as address, phone number, web site, business hours, etc. Those skilled in the art will know how to generate such a location-based list of query results using existing and available Yellow Page databases and directories.

The query results in the location-based list are then ranked based on both spatial relevance and social relevance. In the daycare query example, the spatial relevance of a query result is based on the distance between the location of the daycare provider (as indicated by the daycare provider's address) in the query result and the location specified in the query. For example, a query result that indicates a daycare provider that is located within the city of Saratoga itself may be considered to be spatially more relevant, or have greater spatial relevance, than another query result that indicates a daycare provider that is located in the city of Cupertino, Calif., which adjoins Saratoga. Although this example specifies a city (e.g., Saratoga, Calif.) as the location, other queries may specify a more specific location, such as a street name or a particular street address, and the spatial relevance of a query result may be determined based on how far away the business entity indicated in the query result is from the specific address.

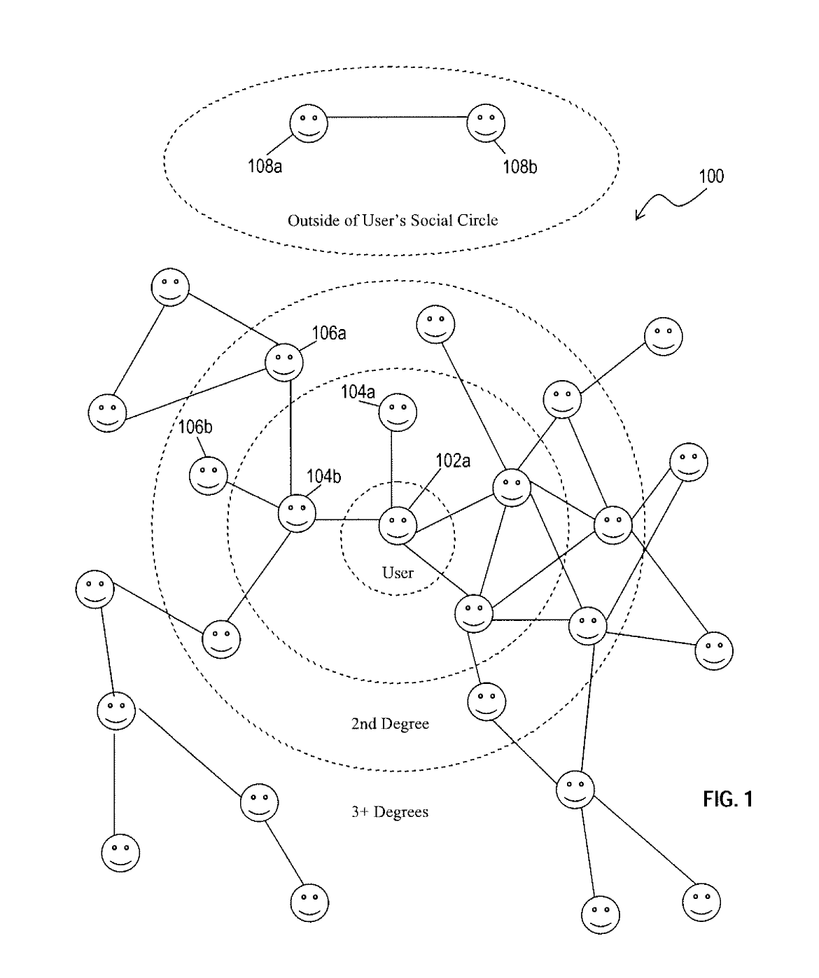

Continuing with the daycare example, the social relevance of a query result is derived based on how users who are socially connected to the user have rated the business entity indicated in the query result. A user who is socially connected to the user may be directly or indirectly connected to the user in one or more social networks, and is referred to herein as a “socially-connected user”. FIG. 1 illustrates social network 100 that is the social network of user 102. Social network 100 may be the user 102's social network on one or more social networks, such as MySpace, Facebook, Linked-in, etc., or may be a social network provided by a service that also provides the search techniques described herein. In social network 100, user 102 is directly connected to immediate friends such as users 104a and 104b. Users 104a and 104 are said to be separated from user 102 by one degree. The immediate friends of users 104a and 104b who are not also the immediate friends of user 102, such as users 106a and 106b, are indirectly connected to user 102, and are said to be separated from user 102 by two degrees. Similarly, there are users (e.g., users 108a and 108b) who are separated from user 102 by a third degree, and so on. Although social network 100 is illustrated with only a certain number of users, a user's social network may include other indirectly connected users without limit. Finally, there may also be users who are not socially connected to user 102 at all, such as users 110a and 110b.

Socially-connected users may have reviewed and/or rated the business entities included in the query results. For example, some socially-connected users of the user may have investigated and/or used the services of daycare providers indicated in the query results. The reviews and ratings of the socially-connected users are typically of higher value and relevance to the user than the reviews and ratings of users who are not socially connected to the user. A social relevance score for a query result may be computed based on the reviews and ratings of the query result's business entity (e.g., daycare provider) provided by the user's socially-connected users. The reviews and ratings of the query result's business may be extracted from the social network, or may be extracted from review-sharing sites such as Yelp if reviews on the review-sharing sites are known to be associated with socially-connected users.

For example, users 104a and 106a may have rated “ABC Daycare” and “XYZ Daycare”, respectively. While user 104a gave “ABC Daycare” a positive rating, user 106a gave “XYZ Daycare” a negative rating. The social relevance of a daycare provider may be computed such that positive ratings from other socially connected users boost the relevance of the daycare provider while negative ratings from other socially connected users lowers the relevance of the daycare provider. In this example, “ABC Daycare” may be considered to be more socially relevant than “XYZ Daycare” because it received more positive feedback from socially connected users.

The list of query results that is finally presented to the user may rank the query results according to the composite scores of the query results that is computed based on both the spatial relevance and the social relevance of the query results. Continuing with the daycare example, it may be that daycare provider “XYZ Daycare” is closer to the specified location than “ABC Daycare”, which means that “XYZ Daycare” is more spatially relevant. However, if “XYZ Daycare” is not as socially relevant as “ABC Daycare”, the composite score may be such that “ABC Daycare” is ranked higher than “XYZ Daycare”. According to one embodiment, the composite score of a query result is computed based on a weighted sum of the spatial relevance score of the query result and the social relevance score of the query result, where the spatial relevance score is computed based on distance of business entity from specified location and the social relevance score is computed based on ratios of positive to negative reviews from socially-connected users. The relative weighting of spatial relevance scores and social relevance scores may be adjusted and may also be specified by the user. For example, if convenience of location is very important to a particular user, that particular user may specify a very high weight for spatial relevance and a very low weight for social relevance. In the daycare example, if a much higher weight is given to spatial relevance, “XYZ Daycare” may be ranked higher in the list of query results provided to the user despite its low social relevance score.

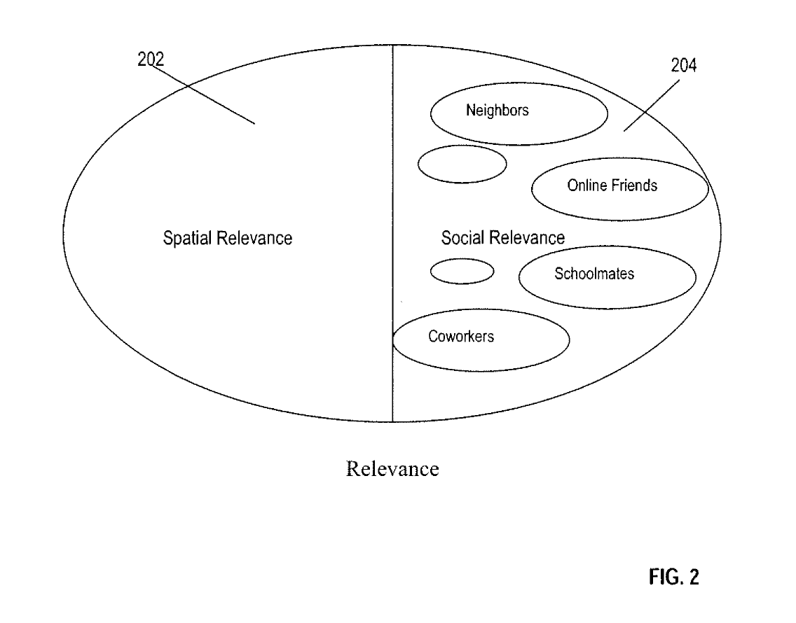

FIG. 2 illustrates different dimensions of relevance. One dimension is spatial relevance 202. Another dimension is social relevance 204. Social relevance 204 illustrates that users may be connected to the query-submitting user in a variety of ways, such as by being the query-submitting user's coworker, neighbor, schoolmate, online friend, etc. According to one embodiment of the invention, social relevance may be computed based on information from a plurality of social networks of the query-submitting user. For example, if the query-submitting user is part of a first social network that includes the user's coworkers and also part of a second social network that includes the user's schoolmates, social relevance information may be extracted from both social networks to compute the social relevance of query results.

According to a further aspect of the present invention, the computation of the social relevance of query results may be adjusted in a variety of ways. For example, how much a review of a business entity affects the social relevance of a business entity may depend on how closely is the reviewer connected to the query-submitting user. In the daycare example, two users A and B may have submitted reviews for daycare provider “ABC Daycare”, where user A is directly connected to the query-submitting user and user B is separated from the query-submitting user by six degrees. The computation of the social relevance of “ABC Daycare” may be such that user A's review is given greater weight in the social relevance score than user B's review because user A is more closely connected to the query-submitting user than user B. For example, if user A gives a positive review and user B gives a negative review, the net social relevance score of “ABC Daycare” will still be high because of user A's positive review.

In another example, only the reviews and ratings of users who are located within a defined area around the specified location of the query are considered in determining social relevance. For example, for the query “daycare” in “Saratoga, California”, only the reviews and ratings of user who live or work within 50 miles of Saratoga, Calif. may be considered, thereby narrowing social relevance information to that provided by local residents. In yet another example, the reviews and ratings of all users may be considered when the location specified by the query is a known travel destination, such as New York City. Since many users who do not live or work in New York may nonetheless have experience dining in New York City, a query for “restaurants” in “New York, N.Y.” may generate query results that are ranked based on social relevance information garnered from all users. In yet another example, a category of business may be determined for the query term, and certain categories of business (e.g., daycare, dry cleaners, plumbers) may be deemed to be “local” categories whose business entities' social relevance is determined based solely from the input of local residents, while other categories of business (e.g., restaurant, spa, park) may be deemed to be “non-local” categories whose business entities' social relevance is determined based on input from all socially connected users.

Users may also customize filter conditions for computing social relevance. For example, a user may specify that only the reviews of users within a certain number of degrees of separation (e.g., 3 degrees of separation) are taken into account. For a particular search, such as a query for “Italian restaurants” in “San Francisco, Calif.”, a user may choose to assign more weight to the reviews another particular user has given in the computation of social relevance, knowing that the other particular use is especially conversant in Italian cuisine.

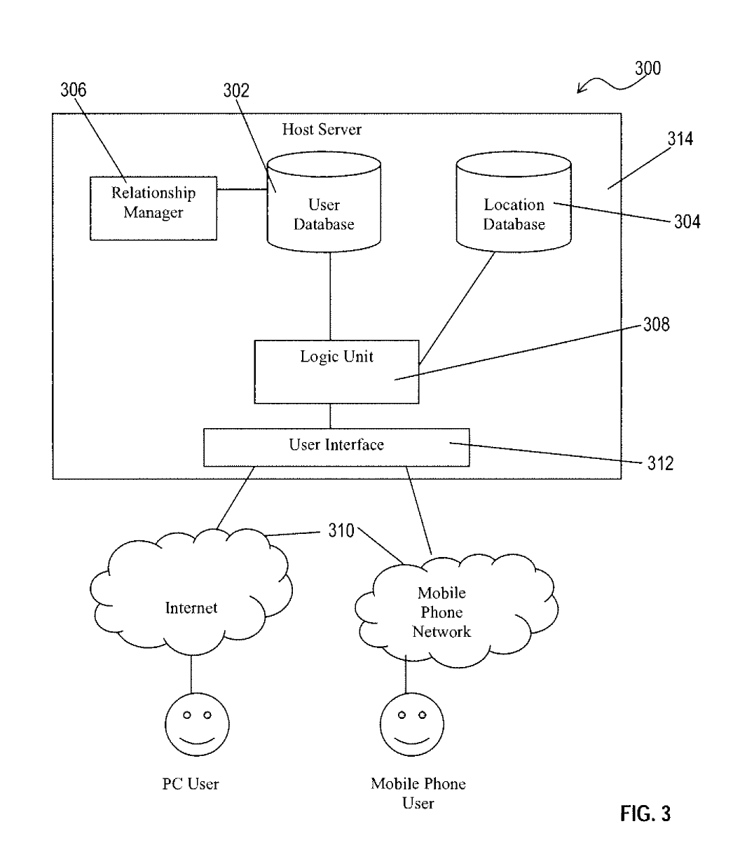

FIG. 3 illustrates a system 300 that may be used to implement aspects of the present invention. System 300 includes user database 302, which contains user accounts and location database 304, which contains addresses, business, and maps. User account information from user database 302 may be used to determine which other users are socially-connected to the user who has submitted a query. Relationship Manager 306 performs algorithms to determine the degrees of separation between users, as well as determines other relationship between users, such as neighbors or coworkers. The databases may reside on permanent media such as a hard disk or on temporary media such as RAM, and can be managed by a database management tool such as Microsoft SQL server.

System 300 also includes logic unit 308, which processes submitted queries, computes relevance scores, and compiles lists of query results that are provided to users. Logic unit 308 performs all other algorithms except those that determine relationships between users. As a user makes submits a query over a communication network 310, the query first arrives at system 300's user interface 312 and is parsed and forwarded to logic unit 308, which in turn performs a search within the location database 304. Then, query results from location database 304 may be further analyzed to determine the social relevance of the query results. Logic unit 308 also performs analyses to determine the spatial relevance of the query results and to generate a final list of ranked query results to provide to the user. As discussed above, the final list of ranked query results may be ranked according to the weighted sums of the query results' spatial and social relevance scores. The final list of ranked query results is then provided to the user through user interface 312.

Communication network 310 may comprise the Internet, a mobile phone network, or any combination of wired and wireless networks, public and private, that may be traversed by users who seek access to host server 314.

According to another aspect of the present invention, in response to receiving a query from a user, where the query specifies a location, a list of query results are generated. Each query result indicates a business entity located within a vicinity of the specified location. Furthermore, the query results are ranked within the list of query results based on both spatial relevance and activity relevance. The spatial relevance of a query result indicates how far the business entity indicated by the query result is away from the specified location. The activity relevance of a query result's business entity indicates how relevant the business entity is to an activity indicated in the query. The spatial relevance and activity relevance of the business entities may be combined in a weighted manner to generate a composite score for each query result and the composite score may be used to rank the query results to provide a ranked list of activity aware and location-based query results to the user for review.

According to one embodiment, the activity relevance of a query result is derived from the activity information associated with the business entity indicated by the query result. The activity information of business entities may be derived from crawling and processing web data on the business entities. Details regarding the processing of web data for deriving activity information are discussed in further detail below. The activity information of a business entity may comprise one or more of: one or more categories associated with the business entity, one or more features associated with the business entity, and one or more experiences associated with the business entity. The activity relevance of a business entity may be derived from how relevant the business entity's associated categories, features, and/or experiences are to the activity specified in the query.

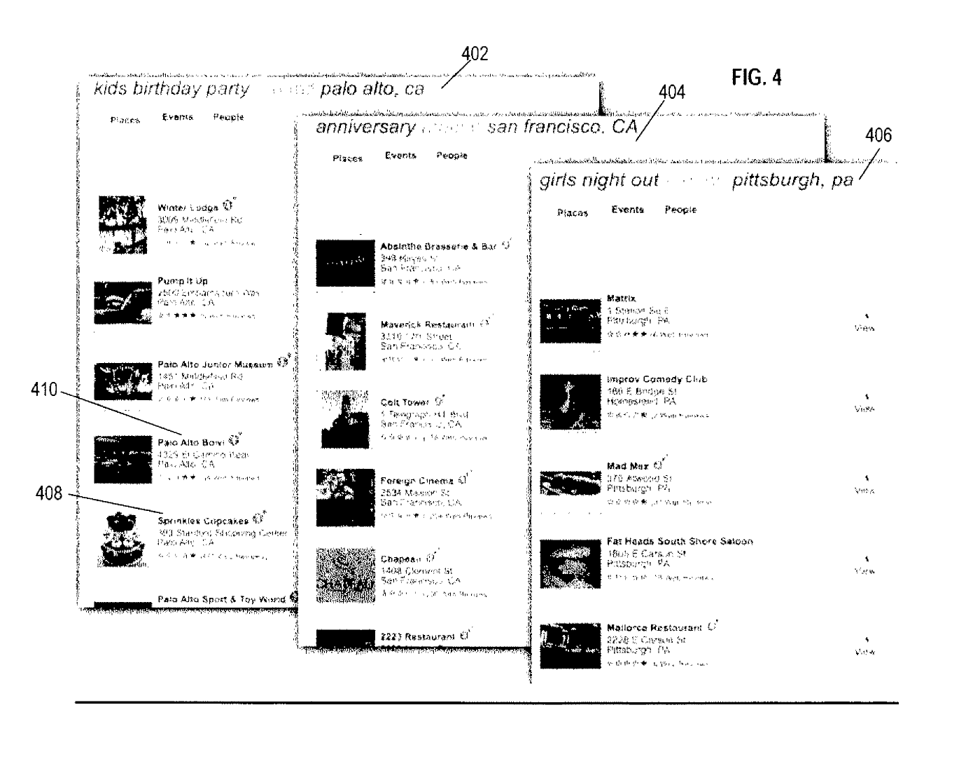

An illustrative example is a query for “kids birthday parties” around “Palo Alto, Calif.”. Upon receiving this query, a search for business entities that are associated with the query term “kids birthday parties” may be conducted in a database that contains category-based activity information for business entities, a database that contains feature-based activity information for business entities, and a database that contains experience-based activity information for business entities. In addition, the location of “Palo Alto, Calif.” is also provided to the databases for searching, so that only business entities that are located in or around Palo Alto, Calif. are searched. The databases may contain location data for business entities in an integrated manner, or may alternatively access the location data from another database. Search results from the databases, which comprise business entities located at or near Palo Alto, Calif. that are associated with the activity of “kids birthday parties”, may be combined into a single list of query results and provided to the user. FIG. 4 illustrates three lists of activity aware query results 402, 404, and 406. Query result list 402, for example, contains a list of business entities located around Palo Alto, Calif., that are relevant to the activity “kids birthday party”.

Referring back to the databases that contain activity information for business entities, category-based activity information for business entities indicates what general categories the business entities belong to. The general categories may be “Dining/eating”, “Shopping”, “Entertainment”, “Lodging”, etc. For example, business entity 408 “Sprinkles Cupcakes” is a cupcake shop, and may belong to the general category of “Dining/eating”. In the database that contains category-based activity information, business entity 408 “Sprinkles Cupcakes” may be associated with the “Dining/eating” category. Category-based activity information may be derived from Yellow Page data about business entities, and a person skilled in the art would know how to extract category-based activity information by accessing Yellow Page data about business entities. A business entity may be associated with more than one category. For example, business entity 410 “Palo Alto Bowl” may be a bowling alley that also provides food and drinks. As such, business entity 410 “Palo Alto Bowl” may be associated with both an “Entertainment” category as well as a “Dining/eating” category. Similarly, some categories such as “Restaurants” may have additional features such as “Pizza (the cuisine)” and “Banquet Hall” and/or “Delivery”—all this information can be used to derive different activities that are suited based on the YP Category.

As discussed above, another database may contain features-based activity information for business entities. A feature of a business entity indicates what the business entity is capable of. For example, a business entity may be associated with the feature “kids menu” because it is a dining establishment that offers kids menus. A business entity may be associated with more than one feature. The business entity that features “kids menu” may also be associated with the features “VISA accepted” and “accepts groups”, for example. In addition to features that indicate whether a business entity has a particular capability, there may also be features that indicate how the business entity is rated or regarded with respect to a particular aspect of utilizing the business entity. For example, there may be a feature of “value”, and there may be data associated with the “value” feature that indicates how the business entity is regarded with respect to the value of its services. The data may be, for example, a number from 1 to 5 where 1 is low value and 5 is high value.

For a business entity, a number of features may be predefined. The predefined features may be the same for all business entities, or may be different for business entities depending on what categories the business entities belong to. For example, there may be a feature “atmosphere” defined for business entities in the “Dining/eating” category but not defined for business entities in the “Automobile services” category. Some other exemplary features include Service, Staff, Management, Price, Location, Transportation, Activities, Ambiance, Physical Features (e.g. Large Windows with View), and so on.

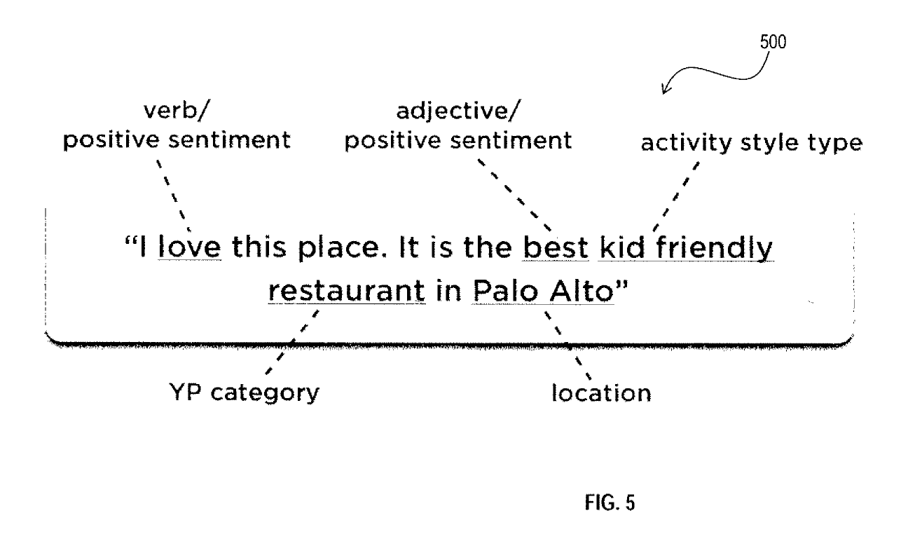

According to one embodiment, the features-based activity information is derived from web data associated with business entities. Web data, such as the web pages of business entities, reviews and ratings of business entities on review sites, blog entries about the business entities, and forum posts about the business entities, etc., is crawled and then processed using natural language processing techniques. Using natural language processing techniques for machine learning, including parts-of-speech tagging and Hidden Markov models, feature-based activity information for business entities may be derived. FIG. 5 illustrates an example sentence 500 that may be parsed and processed according to natural language processing techniques to derive features-based activity information. For example, “kid friendly” is processed to indicate a style type, and “best” is processed as indicating a positive sentiment for “kid friendly” activities. This information may then be stored in the features-based activity information database such that the business entity discussed in example sentence 500 is associated with a “kid friendly” feature. It should be noted that the words parsed and analyzed in web data need not exactly match a predefined feature in order to result in generating data for that predefined feature. For example, the word “cozy” with regard to a restaurant in a review may result in that restaurant being associated with a positive rating with regard to the “atmosphere” feature. Those skilled in the art will know how to use machine-learning, natural language processing, and hidden Markov model techniques to perform the specific analyses used herein.

It should also be noted that the web data processing techniques just described may also be used to derive other types of information for a business entity, such as overall sentiment (e.g., “love”), Yellow Page category (e.g., “restaurant”), and location (e.g., “Palo Alto”).

As discussed above, another database may contain experience-based activity information for business entities. An experience of a business entity indicates what kind of experiences may be had at the business entity. For example, a business entity may be associated with “romantic”, “girls nights out”, or “kids birthday parties”. A single business entity may be associated with more than one experience. The experiences that may be associated with a business entity may be predefined for all business entities or for business entities that belong to a particular category. For example, the “kids birthday parties” experience may be associated with restaurants and parks, but may be unavailable for auto repair shops. Some other exemplary experiences include group events (e.g. group lunch, company outing, etc.), pet friendly, late night activities, upscale activities, kid friendly, educational, health-related and so on.

According to one embodiment, the experience-based activity information is derived from web data associated with business entities, substantially as discussed above with respect to the derivation features-based activity information. In addition, experience-based activity information may be derived from the category-based activity information and/or features-based activity information for a business entity. For example, an experienced defined to be “romantic” may include business entities that are in the “Dining/eating” category and also business entities that have features such as “upscale”, rank high on “atmosphere”, and rank low on “noise”.

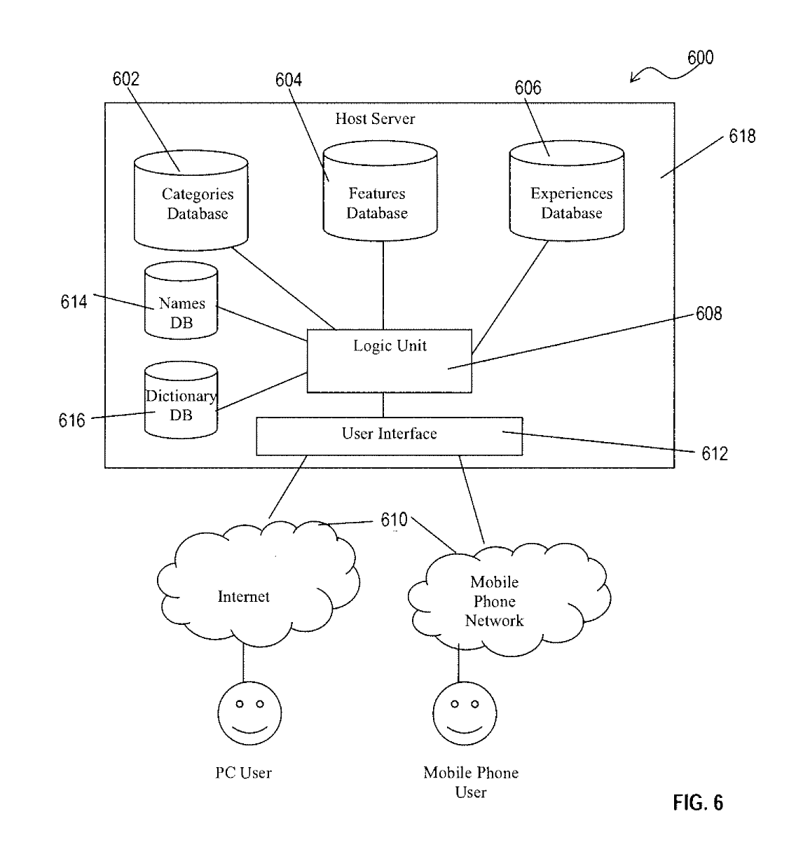

FIG. 6 illustrates a system 600 that may be used to implement aspects of the present invention. System 600 includes category database 602, features database 604, and experience database 606, which contain, respectively, category-based activity information, features-based activity information, and experience-based activity information. The databases may reside on permanent media such as a hard disk or on temporary media such as RAM, and can be managed by a database management tool such as Microsoft SQL server.

System 600 also includes logic unit 608, which processes submitted queries, computes relevance scores, and compiles lists of query results that are provided to users. As a user makes submits a query over a communication network 610, the query first arrives at system 600's user interface 612 and is parsed and forwarded to logic unit 608, which in turn performs a search by concurrently submitting the query to databases 602, 604, and 606. In addition, the query may also be submitted to database 614, which is a database that contains the names of business entities for name look-up and to database 616, which is a database that contains dictionary terms for query term correction. The databases 602, 604, and 606 may each contain location data so that only business entities located around the location specified by the user-submitted query are returned as search results. Alternatively, system 600 may contain another location database. Query results from the databases 602, 604, 606, 614, and 616 are analyzed by logic unit 608 to determine the spatial relevance and social relevance of the query results and to generate a final list of ranked query results to provide to the user. The final list of ranked query results may be ranked according to the weighted sums of the query results' spatial and social relevance scores. The final list of ranked query results is then provided to the user through user interface 612.

Communication network 310 may comprise the Internet, a mobile phone network, or any combination of wired and wireless networks, public and private, that may be traversed by users who seek access to host server 314.

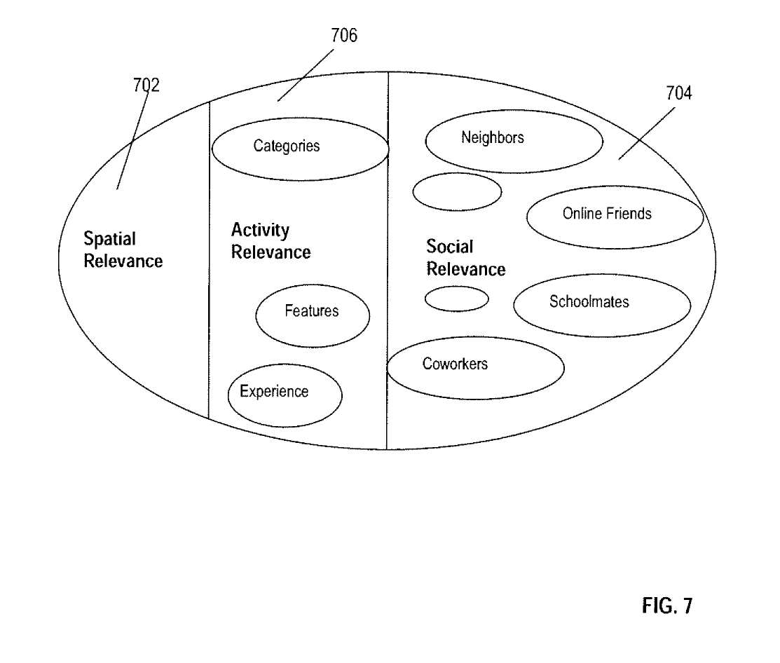

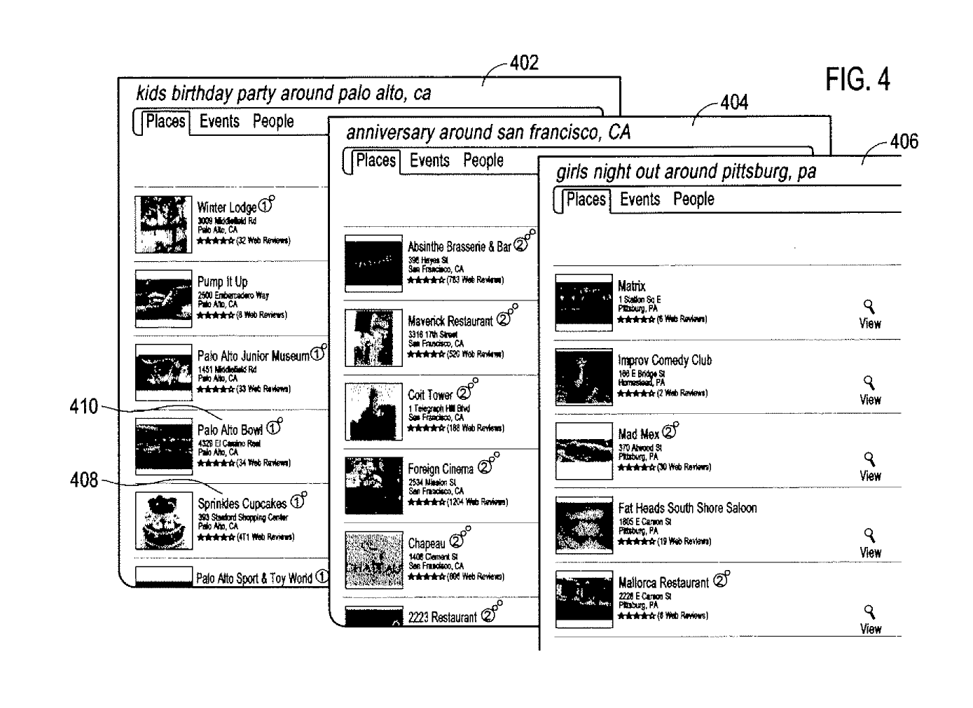

System 600 may additionally include a database for user accounts and a relationship manager, such as user accounts database 302 and relationship manager 306 in system 300, such that social relevance is also token into account when generating and determining the final list of query results to be provided to the user. In this manner, three dimensions of relevance—spatial, social, and activities—are all considered in generating a list of query results. FIG. 7 illustrates the different dimensions of relevance. One dimension is spatial relevance 702. Another dimension is social relevance 704. Yet another dimension is activities relevance 706.

According to another embodiment, in response to receiving a query from a user, the query specifying a location, an activity-based query is automatically generated for a predefined experience. In addition to providing query results to the user that correspond to the submitted query, another set of query results may be provided to the user, the other set of query results generated based on the predefined experience. In this manner, suggestions can be made to a user for various possible intended searches. For example, a user may enter the query “restaurant” in “New York, N.Y.”. Query results may be provided for this query according to the methods described herein with regard to spatial relevance and social relevance. Although this query does not specify a particular experience, query results may nonetheless be generated for a predefined experience that is typically associated with the query term “restaurant”. For example, the predefined experience may be “romantic”, and query results corresponding to “romantic” “restaurants” in “New York, N.Y.” may be additionally provided to the user in another list of query results, along with the suggestion that the query results are relevant for the “romantic” experience.

Furthermore, more than one suggested query result list may be provided. For the example above, the query term “restaurant” may also be typically associated with experience “birthday party” and “business lunch”. Query results relevant for “birthday party” and “business lunch” may then also be provided to the user to suggest what restaurants would be good for “birthday party” and “business lunch” experiences.

According to one aspect of the present invention, in response to receiving a query from a user, where the query specifies a location and an itinerary, a plurality of sub-queries is generated for the query. Each generated sub-query indicates a particular activity. Then, for each sub-query, a list of query results is generated where each query result in the list of query results indicates a business entity located in the vicinity of the specified location that is relevant to the particular activity. The list of sub-query results for each sub-query may be ranked based on both the spatial relevance and the activity relevance of the sub-query results. Then, all the lists of sub-query results may be combined and provided to the user as query results for the specified itinerary at the specified location.

For example, a submitted may be “kids day out” in “New York, N.Y.”. In response to receiving this query, a plurality of sub-queries may be generated, based on predefined information associating itinerary query terms (e.g., “kids day out”) with specific activity query terms (e.g., “kid-friendly restaurant” “kid-friendly entertainment”, etc.). In this example, a first sub-query may be “kid-friendly restaurant” in “New York, N.Y.” and a second sub-query may be “kid-friendly entertainment” in “New York, N.Y.”. Query lists are generated for each sub-query, according to the methods described above. Finally, the results from each query list are combined into a list of itineraries that are provided to the user for review. For example, a list of itineraries may include a first itinerary that includes the top-ranked query result for “kid-friendly entertainment” and the top-ranked query result for “kid-friendly restaurant”, a second itinerary that includes the top-ranked query result for “kid-friendly entertainment” and the second-ranked query result for “kid-friendly restaurant”, a third itinerary that includes the second-ranked query result for “kid-friendly entertainment” and the top-ranked query result for “kid-friendly restaurant”, and so on. Because the query results are also spatially relevant, the itineraries provided to the user include various activities that are located in proximity to each other. In such a manner, itineraries are generated for users that are local and activity-based. The query results generated for itineraries may also be generated based on social relevance, so that business entities favored by the user's friends will be ranked higher.

Systems 300 and 600, and host servers 314 and 618, can be implemented by one or more servers such as those available from Sun, HP, IBM, etc. The one or more servers can further include associated software comprising, for example, operating system(s) (e.g, Solaris, Unix, Linux, etc.), web server(s), database server(s), and other server software. Logic unit 308 and logic unit 608 can be implemented in software, hardware, or a combination of hardware and software, including one or more processors. User interface 312 and user interface 612 may include web server functionality and may be implemented using software such as Apache from Apache, IIS from Microsoft, GWS from Google, etc. A person skilled in the art will know how to implement systems 300 and 600 based on the techniques described herein.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

1-33. (canceled)

34. A method comprising:
receiving a query regarding entities at a query location from web-based search engine on a user device;
generating, by a processor of a computing device, a list of query results in response to the query and the query location received from the web-based search engine, wherein each query result identifies an entity;
determining, for each query result, whether a category for the entity identified in the query result is a local category or a non-local category relative to the query location;
accessing a web-based social network to which the user belongs;
identifying, for each query result for which the entity identified in the query result is determined to be of the local category, a set of reviews for the entity identified in the query result from one or more selected reviewers, each selected reviewer being connected to the user in the social network within a user-specified degree of separation in connection and having a predetermined spatial relationship with the query location including being located within a predetermined radius of the query location;
ranking each query result based on a spatial relevance of the entity identified in the query result and based on the identified set of reviews for the entity from the one or more selected reviewers; and
providing the ranked query results to the user device.

35. (canceled)

36. The method of claim 34, wherein the spatial relevance is computed based on a distance of the entity from the query location.

37. (canceled)

38. (canceled)

39. (canceled)

40. (canceled)

41. The method of claim 34, wherein the one or more reviewers are directly connected to the user in the social network.

42. The method of claim 34, wherein the category is indicated in the query result.

43. The method of claim 34, wherein determining the category for the entity includes determining a category of business from a term in the query result.

44. (canceled)

45. (canceled)

46. (canceled)

47. (canceled)

48. (canceled)

49. The method of claim 34, further comprising:
weighting each review in the set of reviews based on a number of degrees of separation of the reviewer from the user in the social network.

50. (canceled)

51. (canceled)

52. (canceled)

53. A system comprising:
one or more memory devices arranged and configured to store executable code; and
one or more processors operably coupled to the one or more memory devices, the processors being arranged and configured to execute the code such that the system:
receives a query regarding entities at a query location from a web-based search engine on a user device;
generates a list of query results in response to the query and the query location received from the web-based search engine, wherein each query result identifies an entity;
determines, for each query result, whether a category for the entity identified in the query result is a local category or a non-local category relative to the query location;
accesses a web-based social network to which the user belongs;
identifies, for each query result for which the entity identified in the query result is determined to be of the local category, a set of reviews for the entity identified in the query result from one or more selected reviewers, each selected reviewer being connected to the user in a social network within a user-specified degree of separation in connection and having a predetermined spatial relationship with the query location including being located within a predetermined radius of the query location;
ranks each query result based on a spatial relevance of the entity identified in the query result and based on the identified set of reviews for the entity from the one or more selected reviewers; and
provides the ranked query results to the user device.

54. The system of claim 53, wherein the processors are arranged and configured to execute the code such that the system computes the spatial relevance based on a distance of the entity from the query location.

55. The system of claim 53, wherein the one or more reviewers are directly connected to the user in the social network.

56. The system of claim 53, wherein the category is indicated in the query result.

57. The system of claim 53, wherein the processors are arranged and configured to execute the code such that the system computes determines the category for the entity by determining a category of business from a term in the query result.

58. The system of claim 53, wherein the processors are arranged and configured to execute the code such that the system computes an activity relevance of the entity identified in the each query result.

59. The method of claim 53, wherein the processors are arranged and configured to execute the code such that the system weighs each review in the first set of reviews based on a number of degrees of separation of the reviewer from the user in the social network.

60. A method comprising:
receiving a query regarding entities at a query location from a web-based search engine on a user device;
generating, by a processor of a computing device, a list of query results in response to the query and the query location received from the web-based search engine, wherein each query result identifies an entity;
accessing a web-based social network to which the user belongs;
identifying, for each query result, a set of reviews for the entity identified in the query result from one or more selected reviewers, each selected reviewer being connected to the user in the social network within a user-specified degree of separation in connection and having a predetermined spatial relationship with the query location including being located within a predetermined radius of the query location;
ranking each query result based on a spatial relevance of the entity identified in the query result and based on the identified set of reviews for the entity from the one or more selected reviewers; and
providing the ranked query results to the user device.

61. The method of claim 60, wherein the spatial relevance is computed based on a distance of the entity from the query location.

62. The method of claim 60, wherein the one or more reviewers are directly connected to the user in the social network.

63. The method of claim 60, wherein the category is indicated in the query result.

64. The method of claim 60, wherein determining the category for the entity includes determining a category of business from a term in the query result.

65. The method of claim 60, further comprising:
weighting each review in the set of reviews based on a number of degrees of separation of the reviewer from the user in the social network.

66. The method of claim 60, wherein the processors are arranged and configured to execute the code such that the system computes an activity relevance of the entity identified in the each query result.
